(19) United States
(12) Patent Application Publication
(10) Pub. No.: US 2008/0291481 A1
(43) Pub. Date: Nov. 27, 2008

(54) Facility for Processing Printed Matter and Method for Processing Printed Matter

(75) Inventor: Jurg Paul Haller, Madrid (ES)

Correspondence Address: GUDRUN E. HUCKETT DRAUDT, SCHUBERTSTR. 15A, WUPPERTAL, 42289, DE

(73) Assignee: PRINTFINISH GMBH, Markkleeberg (DE)

(21) Appl. No.: 12/125,079

(22) Filed: May 22, 2008

(30) Foreign Application Priority Data
May 22, 2007 (DE) 10 2007 025 774.2

(51) Int. Cl. G06F 3/12

(52) U.S. Cl. 358/1.13

(57) ABSTRACT

A facility for processing printed matter has at least one feed device for printed matter and at least one handling station. A system control unit is provided. At least one reading station is positioned in a transport path of the printed matter, wherein the at least one reading station supplies information correlated with the printed matter as signals to the system control unit and, based on the signals, the system control unit at least partially automatically adjusts the facility for a job to be performed.

### BACKGROUND OF THE INVENTION

The invention relates to a facility for processing printed matter, preferably an enveloping facility, comprising at least one feed device for printed matter and at least one handling station. The invention also relates to a method for processing printed matter, preferably by means of a facility as specified above.

Printed matter, for example account statements, brochures, letters and the like, are processed for example by being stacked, sorted and the like. Before beginning such a job, data must be input into the processing facility by hand or partially by hand and partially via a monitor in order to set up or adjust the facility with respect to the job to be performed. Frequently, such facilities are provided with several feed or transport devices so that it is then necessary to carry out adjustments for each feed device; also, the leading feed device must be defined. Once the job has been completed, the processing facility will stop. For a subsequent job, the appropriate input must be entered into the processing facility for adjusted the system with respect to the subsequent job. The operators must be knowledgeable with regard to job input, job set-up, and system configuration. When inputting or setting up a job in the facility, errors can occur that will impair the processing safety of the printed matter. Moreover, production interruptions are required each time a new job is to be processed. When many jobs with only small numbers of pieces of printed matter are to be performed, the productivity of the facility decreases.

### SUMMARY OF THE INVENTION

It is an object of the present invention to configure a processing facility of the aforementioned kind and a method of the aforementioned kind in such a way that an optimal processing safety is provided and high productivity is achieved.

In accordance with the present invention, this is achieved in regard to the processing facility in that the processing facility has at least one reading station that is located in the transport path of the printed matter and supplies information correlated with the printed matter as signals to a system control unit with which signals the processing facility is at least partially automatically adjustable for the job to be performed.

In accordance with the present invention, this is achieved in regard to the method in that, before processing (stacking, compiling, sorting etc.) the printed matter, the processing facility is adjusted automatically to the job to be performed in that signals are supplied to the system control unit which signals are generated based on information correlated with the printed matter to be processed.

By means of the processing facility according to the invention and the method according to the invention, it is possible to automatically adjust the processing facility for any job to be performed. Operator input that can lead to errors is no longer required. The information correlated with the printed matter is supplied in the form of signals to the system control unit that, in accordance with the signals, adjusts or sets up the processing facility. As a result of automatic adjustment of the processing facility, continuous processing of the stream of printed matter is possible. As soon as a first job has been completed, immediately the adjustment of the processing facility for a subsequent job is realized and the subsequent job can then be carried out immediately afterwards. Advantageously, the information is arranged at an appropriate location, e.g. printed or deposited, in the printed matter stream. This information is advantageously read out during processing of the printed matter stream in the processing facility. In this way, the processing safety is significantly increased and operator errors are prevented.

### BRIEF DESCRIPTION OF THE DRAWING

FIG. 1 is a schematic plan view of an enveloping facility according to the invention with two processing systems.

FIG. 1a shows schematically the interrelation between the system control unit and the systems and stations of FIG. 1.

FIG. 2 is a schematic illustration of the production flow of the document streams in the enveloping facility according to FIG. 1 in which job A is being processed.

FIG. 3 is an illustration in accordance with FIG. 2 of the production flow of the document streams at a later point in time.

FIG. 4 shows the production flow of the document streams at the time of terminating job A.

### DESCRIPTION OF PREFERRED EMBODIMENTS

In the following, by means of the example of an enveloping facility for printed matter, a printed matter processing facility will be explained with which an automatic job control is possible. The systems are automatically adjusted in such a way that the job or order can be completed by the facility, respectively. A manual adjustment of parts of the enveloping facility is not required.

The method will be described with the aid of an enveloping facility but the method is not limited to such an enveloping facility. By means of the method, other printed matter processing facilities can be adjusted automatically such that they can fulfill the required tasks, respectively.

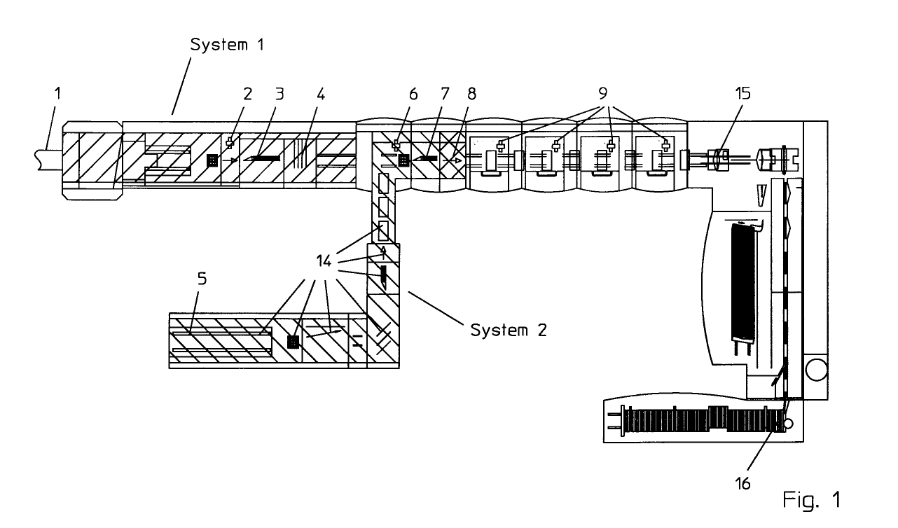

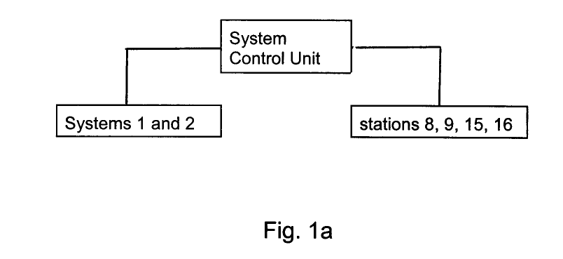

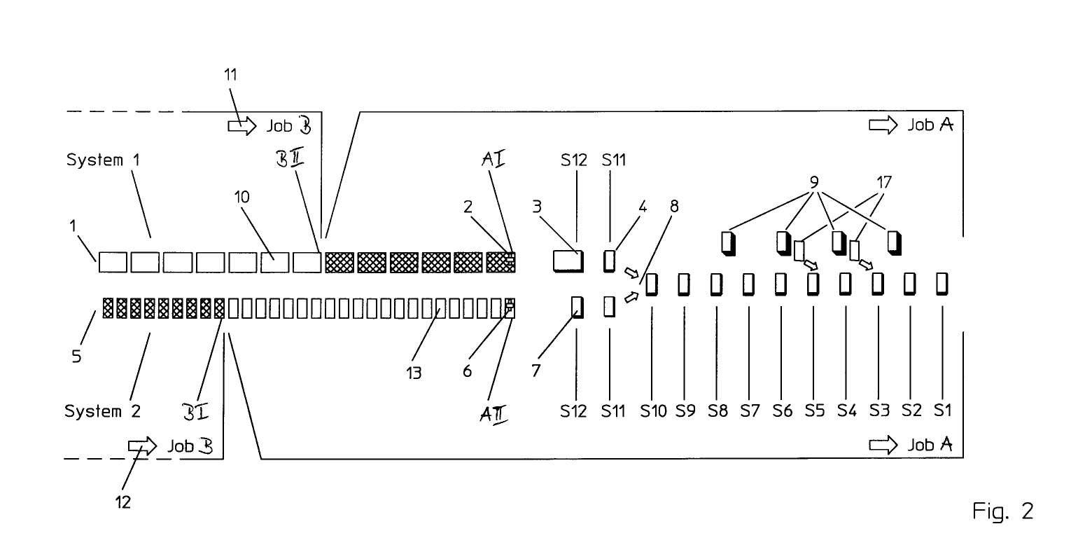

With the aid of FIGS. 1 to 4, an enveloping facility will be described that selectively compiles and processes mailings. As an example, in FIG. 1 two document streams 1 and 5 are supplied to the schematically illustrated enveloping facility and processed in the enveloping facility. Each document stream 1, 5 is comprised of printed sheets that can be personalized documents of various types and/or formats. As shown in an exemplary fashion in FIG. 2, the document stream 1 is comprised of DIN A4 sheets 10 that are positioned minimally spaced from one another sequentially in the transport direction 11. The document stream 5 is comprised also of sheets 13 that are positioned minimally spaced from one another sequentially in the transport direction 12. In contrast to the sheets 10 of the document stream 1 the sheets 13 have a different format. The two document streams 1, 5 can of course also be comprised of sheets of the same format.

The sheets 10, 13 are compiled to a set or a partial set at the compiling stations 3 or 7. Such a set or partial set can be for example the contents of a letter to be inserted into an envelope. In this connection, a set can be comprised of a single of several correlated sheets 10, 13.

One or several correlated sets represents a job, for example, an order.

The enveloping facility according to FIG. 1 has a transport path on which the sheets 10 of the document stream 1 are transported sequentially while lying flat. This transport path belongs to system 1 of the enveloping facility. On the transport path the sheets 10 of the document stream 1 are supplied to at least one reading head 2 by means of which codes provided on the sheets 10 can be read. These codes can be printed, glued, or applied in other ways to the sheets 10. The code contains not only information in regard to the sets that are to be compiled from the respective sheets 10 but also information with regard to the adjustment or setup of the enveloping facility when changing an order or job.

The compilation of the sheets 10 to sets is automated and realized for example by reading the codes on the sheets by means of the reading head 2. The codes can be bar codes or 2D bar codes. Reading of the codes can also be done by OCR methods. Further, transponders can be employed that transport the corresponding information through the reading head 2 for read-out.

Downstream of the reading station there is a compiling station 3 in which the sheets 10 are compiled to the appropriate set, respectively. Based on the codes, the sheets 10 correlated with a set are automatically compiled. Subsequently, the sets that are generated in compiling station 3 are supplied to a downstream folding station 4 where the sets are folded to the desired size. In which way the sets are to be folded is also read out by the reading head 2 from the codes.

The reading head 2, the compiling station 3, and the folding station 4 are components of the system 1.

The enveloping facility comprises a further system 2 by means of which the document stream 5 is supplied. The sheets 13 of the document stream 5 are transported sequentially by means of a feed or transport device 14. The feed device of the system 2 has a 90 degree deflection where the sheets 13 are deflected along their transport path. At the location where the supply of the document stream 1 is met, a further 90 degree deflection of the transport path of the sheets 13 is realized. In this area, at least one reading head 6 is provided with which, similar to the reading head 2, codes of the sheets 13 can be read. Based on the read codes, the sheets 13 can be combined or compiled to the appropriate sets. Moreover, the codes provided on the sheets 13 contain also information based on which the enveloping facility is adjusted automatically in such a way that the job to be performed with the sheets 13 can be carried out.

Downstream of the reading head 6 there is a compiling station 7 where the sheets 13 are combined to sets in accordance with the read-out code information. The set can comprise one or several sheets 13.

The reading head 6 and the compiling station 7 are components of the system 2 of the enveloping facility.

Because each of the systems 1 and 2 of the enveloping facility is provided with a reading head and a compiling station, both systems can be used as leading systems as needed.

Downstream of the compiling station 7 there is a combining station 8 where the systems 1 and 2 come together and their sets are combined.

Downstream of the combining station 8 at least one insert station 9 can be provided where additional inserts or flyers can be added to the sets. In the illustrated embodiment, four insert stations 9 are arranged sequentially behind one another. It is thus possible to add four identical inserts or different inserts to the sets.

Subsequently, the completed sets are supplied to an enveloping station 15 where the sets are inserted into envelopes; such enveloping steps and enveloping stations are well known to a person skilled in the art. The envelopes are then collected in a collecting station 16; such collecting steps and collecting stations are well known to a person skilled in the art.

With the aid of FIGS. 2 to 4, the sequence of actions within the envelope facility will be explained in detail. In the illustration according to FIG. 2, job A is being processed. For this job A, the system 1 is the leading system AI in the enveloping facility; system 2 is the trailing system AII. The sheets 10 of the document stream 1 that belong to the job A are identified by cross-hatching. The sheets 10 are read first by means of the reading head 2. Subsequently, in accordance with the code information the sheets 10 are compiled in the compiling station 3 to the set S12. In FIG. 2, to the right of the set S12 the already completed sets S1 to S11 are shown.

Parallel to the generation of the sets in the compiling station 3 the sheets 13 are supplied by document stream 5. For reasons of simplifying the illustration, the document stream 5 in FIG. 2 is shown parallel to the document stream 1. The sheets 13 of the document stream 5 that belong to job A are enclosed by a frame. In the reading head 6 code information of the sheets 13 is detected and utilized in order to combine in the compiling station 7 of the system 2 the sheets 13 to the set S12.

The set S12 of the system 1 is folded in half in the folding station 4, or folded in a Z fold or in a C fold; this is shown in FIG. 2 for the set S11. The set S12 of the system 2 is not folded.

The folded set S11 of the system 1 and the unfolded set 11 of the system 2 are fed to the combining station 8 in which the two sets are combined to a single set S10 in accordance with the code information of the sheets 10, 13.

During further transport at least one insert 17 from one or several of the insert stations 9 is added to the combined set S10. Depending on the code information not all sets are supplied with inserts but only those for which an insert 17 is intended in accordance with the code information. When several insert stations 9 are provided, different types of inserts can be present so that, as needed, different insert 17 are selectively added to the sets, if necessary. In FIG. 2, it is illustrated as an exam pie that only from two insert stations 9 inserts 17 are supplied and these inserts are added to the sets S3 and S5.

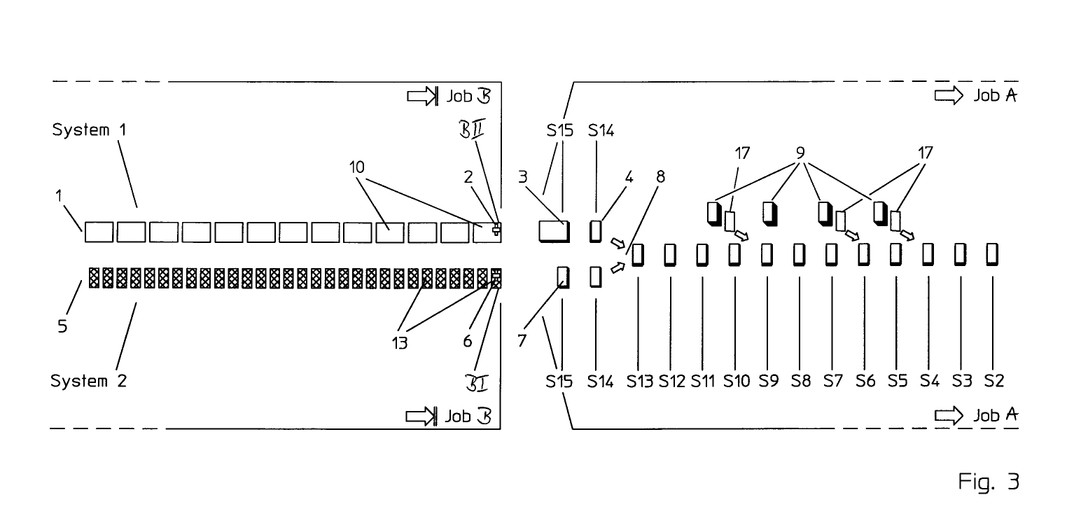

After having passed the insert stations 9 the set provided for job A is completed. The job A, as shown in FIG. 3, is comprised of a several different sets S1 to S15 that can be identical but can also be different.

FIG. 3 shows the situation in the enveloping device at a later point in time. Job A is still being processed while job B is waiting to be processed. The reading heads 2, 6 read on the first sheets 10 and 13, respectively, that now job B is to be carried out. The reading heads 2, 6 accordingly send a stop signal to the feed device so that the document stream 1, 5 is stopped in the position illustrated in FIG. 3. In this position, the first sheet 10 or 13 of the two document streams 1, 5 of job B is positioned underneath the reading head 2 or 6, respectively. The job A is continued until all sheets 10, 13 for the job A are combined and completely processed.

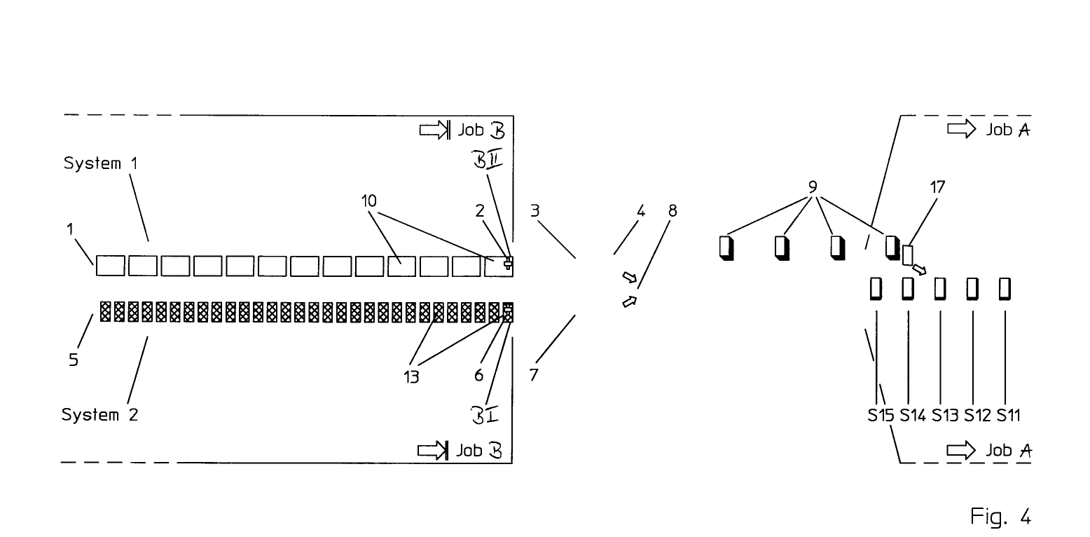

FIG. 4 shows the end phase of processing job A. The sheets 10, 13 for the subsequent job B are still in the stopped position according to FIG. 3. All sets of the job A as well as the envelopes in the enveloping station 15 are removed after completion of job A from the enveloping facility. As soon as this process has been completed, a signal is generated with which the next functions are activated in the enveloping facility for processing job B. The signals generated by the reading heads 2, 6 are supplied to the system control unit and, based on these signals, the system control unit adjusts the enveloping facility such that the subsequent job B can be performed. As an example, the facility is adjusted based on the signals in such a way that the sheets 10, 13 are combined in the correct sequence to form the sets. Moreover, the facility can be adjusted such that only the required stations are activated. For example, when no inserts 17 are required, the facility is automatically set up such that the insert stations 9 are deactivated. Depending on the size of the sheets 10, 13 stops are provided in the facility, for example, in such a way that the sheets, in accordance with their formats, can be stopped in the correct position and/or folded. Depending on the information that is being provided by means of the codes of the corresponding sheets 10, 13, the facility can be adjusted automatically to the job to be performed. Manual adjustment or adjustment by operating personnel on a operator terminal is no longer required in the facility according to the present invention so that errors made by operating personnel are prevented.

At the same time, the facility can be adjusted with regard to whether the system 1 or the system 2 is the leading system. In the illustrated embodiment, the facility is set up for processing job B such that now system 2 is the leading system BI while system 1 is the trailing system (BII). The information for converting the facility in this regard are also contained in the codes of the corresponding sheets 10, 13 of the document streams 1, 5 and are therefore read out by means of the reading heads 2, 6.

The enveloping facility illustrated as an exemplary embodiment of the invention has two systems 1 and 2 for supplying the documents (printed matter). It can of course also have additional feed systems. In this case, all feed systems have a reading station in order to read the information provided in the codes of the sheets supplied by means of these systems and to set up the facility accordingly. When changing jobs, the system lead can therefore be assigned to another one of the systems integrated in the facility.

When different types of envelopes and/or other inserts 17 are required for the subsequent job to be performed in accordance with the coded information, the operator is requested to load these components (envelopes, inserts, etc). Once the operator has exchanged the envelopes and/or inserts, the facility can be switched again to automatic operation.

However, it is also possible that the exchange of envelopes and/or inserts 17 can be done automatically or can be monitored. In this case, the supply of the documents is stopped until in the insert stations 9 and/or in the enveloping station 15 the components have been exchanged. In this case, reading stations are advantageously integrated in the trays for the inserts 17 correlated with the insert stations 9 and/or the tray for envelopes correlated with the enveloping station 15. With these reading stations it is automatically monitored that the correct inserts or envelopes are inserted into the stations 9, 15. For exchanging the inserts and envelopes, handling devices can be provided which are controlled by the system control unit in accordance with the signals received from the reading heads 2, 6.

After all information has been processed and the set-up work has been completed, processing of the new job B begins.

In FIG. 4, by cross-hatching of the sheets 13 it is indicated that the system 2 now is the leading system BI for processing job B. The sheets 10, 13, as has been explained in connection with FIGS. 2 and 3, are combined to the different sets.

Once this job B has been completed, processing of the next job C is carried out in the way described above. In this connection, the facility parts are again adjusted so as to meet the requirements for performing this new job C.

In the illustrated embodiment, the information with regard to processing of the new job is provided on the first sheet 10 or 13 of the new job. However, it is also possible to provide this information on a separate document that after reading the information for adjusting the system is removed from the respective document stream 1, 5. The sheet can also remain as a separating sheet between sequential jobs.

In another method variant information for a job change are integrated into the code of the first document 10 or 13 for the first set of the new job. This requires a suitable code variant in order to be able to include a large volume of information.

In accordance with another variant, the information for converting the facility to a new job can also be provided within the code of the last document of the job still being processed.

It is furthermore possible to divide the information between the codes. For example, a first part of the information can be contained in the code of the last document of the currently processed job and a second part of the information can be contained in the code of the first document of the subsequent job. In this case, the first part of the information advantageously contains data based on which the facility can generate signals for terminating the job still being processed. In the second part, information for converting the facility to the requirements of the new job are contained.

In the described embodiments the reading heads 2, 6 are stationary. This requires that the codes are present always at the same location of the documents 10, 13. Accordingly, when designing the print layout of the documents 10, 13, the position of the respective code must be taken into account. In order to avoid this limitation, the reading heads 2, 6 can also be arranged to be automatically adjustable. It is then possible to scan the entire area of the documents 10, 13. Therefore, the code must not be arranged at a predetermined location on the document 10, 13 so that the placement of the code must not be taken into account when designing the print layout. As soon as the reading head 2, 6 has found the code when scanning the document 10, 15, the information contained in the code is read and the information is supplied to the system control unit. Scanning of the document 10, 13 can be realized line by line in that the reader heads 2, 6 scans the document 10, 13 line by line in a controlled fashion until the code has been found.

The scanning process can of course also be done in other ways. For example, the reading heads 2, 6 can scan the document 10, 13 column by column. The type of scanning depends on how the movement of the reading head is programmed.

It is particularly advantageous when the information detected by the reading head 2, 6 is filed in a database and saved with an assigned number. When the job to be performed is for example a repeat job, this means that in the database there is already information for processing such a job from a job processed earlier. Only the required information is added that is new in regard to the new job to be processed; the remaining information can be retrieved from the database so that the facility can again be set up completely automatically when performing the repeat job.

When the new job to be performed has no predecessor job, all information is read from the code and entered in the database. To this data set all information is added that is required for adjusting or setting up the facility for processing the job characterized by the data set.

When it is generally not possible to include a larger data volume as a result of the code variant, it is however possible to operate the facility according to the method for processing printed matter according to claim 11 and claim 17. In this case, the detailed information of the jobs are saved before processing in the database of the facility. This database can be expanded continuously by entering new jobs. The information correlated with the printed matter to be processed contains only job identifying numbers or the like that activate the appropriate information for job control in the database and then initiate the described functions.

The facility can be completely automatically operated, inclusive of exchanging the inserts 17 and/or the envelopes, so that the enveloping facility operates at high output and without errors. Even the removal of the final product from the collecting station 16 can be done completely automatically. Since the filled envelopes are sequentially deposited in the collecting station 16 in accordance with their processing within the respective jobs A, B, . . . , the envelopes belonging to a particular job can be removed without problems by an appropriate handling device from the collecting station 16.

The specification incorporates by reference the entire disclosure of German priority document 10 2007 025 774.2 having a filing date of May 22, 2007.

While specific embodiments of the invention have been shown and described in detail to illustrate the inventive principles, it will be understood that the invention may be embodied otherwise without departing from such principles.

What is claimed is:

1. A facility for processing printed matter, the facility comprising:
at least one feed device for printed matter;
at least one handling station;
a system control unit;
at least one reading station positioned in a transport path of the printed matter, wherein the at least one reading station supplies information correlated with the printed matter as signals to the system control unit and, based on the signals, the system control unit at least partially automatically adjusts the facility for a job to be performed.

2. The facility according to claim 1, wherein the at least one reading station has at least one reading head.

3. The facility according to claim 1, wherein the information is provided on a data carrier that is part of the printed matter to be processed.

4. The facility according to claim 1, wherein the information is provided on a data carrier that is part of a carrier separate from the printed matter.

5. The facility according to claim 1, wherein the at least one handling station is a compiling station for generating sets of printed matter.

6. The facility according to claim 1, wherein the at least one handling station is a folding station.

7. The facility according to claim 1, further comprising a combining station, wherein the printed matter of the at least one feed device is supplied to the combining station.

8. The facility according to claim 7, comprising two of the at least one feed device wherein the printed matter of said two feed devices is supplied to the combining station.

9. The facility according to claim 1, wherein, based on the signals of the at least one reading station, one of the at least one feed device is automatically selected as a leading feed device.

10. The facility according to claim 1, comprising at least one insert station.

11. A method for processing printed matter in a processing facility, the method comprising the step of:
automatically adjusting the processing facility to a job to be performed by supplying signals to a system control unit which signals are generated from information correlated with the printed matter that is being fed to the processing facility for processing.

12. The method according to claim 11, further comprising the step of reading the information from at least one data carrier.

13. The method according to claim 12, wherein the at least one data carrier is provided on a piece of printed matter.

14. The method according to claim 12, wherein the at least one data carrier is a carrier separate from the printed matter.

15. The method according to claim 11, wherein the information is present on a last piece of printed matter of a preceding job.

16. The method according to claim the 11, wherein the information is present on a first piece of printed matter of a subsequent job.

17. The method according to claim 11, wherein the information is partially read from a data carrier and partially retrieved from a date base.

18. The method according to claim 11, comprising the step of holding the printed matter of a second job until completion of a first job.

19. The method according to claim 18, comprising the step of automatically adjusting, based on the information of the second job, the facility before processing the second job.
